(19) United States
(12) Patent Application Publication
(10) Pub. No.: US 2014/0340234 A1
(43) Pub. Date: Nov. 20, 2014

(54) Flag

(71) Applicant: A HOT FLAG LLC, Warren, OH (US)

(72) Inventors: Deborah L. Wojnarski, Niles, OH (US); Michael K. Roberts, Warren, OH (US)

(21) Appl. No.: 14/120,307

(22) Filed: May 14, 2014

Related U.S. Application Data
(60) Provisional application No. 61/823,123, filed on May 14, 2013.

(51) Int. Cl. G09F 17/00; H05B 37/02; F21S 10/06

(52) U.S. Cl. CPC G09F 17/00; F21S 10/06; H05B 37/0236
USPC 340/815.46; 362/249.01; 362/249.12

(57) ABSTRACT

A flag assembly for presentation of at least one electrically-powered entity identifying source. The flag assembly includes a pole, a piece of material attached to the pole, and at least one electrically-powered entity identifying indicia within the assembly.

### CROSS-REFERENCE TO RELATED APPLICATION

This application claims the benefit of and priority to U.S. Provisional Patent Application Ser. No. 61/823,123, entitled LIGHTED FLAG and filed May 14, 2013, the entire disclosure of which is incorporated herein by reference, to the extent that it is not conflicting with the present application.

### BACKGROUND

Flags are popular display items in many cultures. For many centuries, a flag has been used for many purposes, such as for example, to represent a particular country, region, amateur or professional sports team, college or university, clan or other group of people or entity. Flags are typically made of one or more type of material, and often are displayed in a manner to promote visibility, such as for example, from a flag pole or hung above ground in another manner to give added visibility to the flag. The image of a flag can also be displayed for observation on another object, such as for example, a building, a ship or an article of clothing.

A physical flag displayed during the daytime may be lowered and stored during evening hours. Alternatively, the flag may be illuminated in darkness and low light by a remote source, such as for example, a set of spotlights mounted on the ground. Such a remote source of light often illuminates the entire flag with equal intensity. If the power source to the remote source of light is interrupted, visibility of the flag by an observer is impaired.

### SUMMARY

The present application describes a flag assembly having at least one electrically-powered entity identifying source within the assembly.

In an exemplary embodiment, a flag assembly includes a pole, a piece of material attached to the pole, and at least one electrically-powered entity identifying indicia within the assembly, such as embedded in the piece of material or encased within the flag pole. The material may define indicia on at least one face. A plurality of light sources may form a pattern complementing the indicia. The assembly may include a speaker adapted to play at least one sequence of audible tones.

Further features and advantages of the invention will become apparent from the following detailed description made with reference to the accompanying drawings.

### BRIEF DESCRIPTION OF THE DRAWINGS

Features and advantages of the general inventive concepts will become apparent from the following detailed description made with reference to the accompanying drawings.

FIG. 1 is a front perspective view of a flag assembly;

FIG. 2 is a front view of the flag assembly of FIG. 1;

FIG. 3 is an exploded assembly view of the flag assembly of FIG. 1;

FIG. 4 is a sectional view of the flag assembly of FIG. 1, shown along the longitudinal axis of the flag pole; and

FIG. 5 is a front partial view of the flag assembly of FIG. 1, shown placed in a flag stand.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, percentages and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The term “flag” as used in the specification and the claims is to be interpreted broadly. Specifically, the term “flag” is to be understood to include more than a piece of rectangular shaped material, and includes a variety of shapes, such as for example, a pennant, bunting, banner or burgee, and includes a variety of materials, such as for example, cloth, plastic card, paperboard or corrugated.

The term “entity-identifying source” as used in the specification and the claims is to be interpreted broadly. Specifically, the term “entity-identifying source” is to be understood to include a variety of patterns, brands, colors, sounds, or repetitions which an observer or listener would recognize or to which would give attention, such as for example, a sports team or university trademark, a song, a light pattern, or a color.

The present invention is a flag assembly that offers a new and exciting way to observe and enjoy flags, by using some combination of lights and sound. By placing light sources on a flag in a complementing pattern relative to indicia on the flag, the flag is more visible to an observer when the flag is displayed either inside or outside. An audio recording of sounds, such as a song, which corresponds to the indicia on the flag increases the recognition and enjoyment of the observer. The inventive flag assembly is useful in many applications, such as for example, the sports, gaming, wedding or event industries.

The present application describes a flag assembly. The flag assembly provides a flag having indicia on at least one side and a plurality of lights complementing the indicia. The flag assembly is highly visible at night when displayed outside, and inside during times in which the conventional lights are not powered.

One embodiment of the invention features a flag assembly including a pole, a piece of material attached to the pole, and at least one electrically-powered entity identifying indicia within the assembly. The at least one electrically-powered entity identifying indicia may be of various forms, such as sound from a speaker, lights which flash in rhythm with the sound, or a set of lights which accent or emphasize non-electrical indicia.

Another embodiment of the invention features a flag assembly having a pole, a piece of material, and a plurality of light sources. The piece of material is attached to the pole for display. The material defines an indicia on at least one face. The plurality of light sources is attached to the piece of material in a pattern complementing the indicia.

Another embodiment of the invention features a flag assembly having a pole, a piece of material, a plurality of light sources, and at least one speaker adapted to play at least one sequence of audible tones. The at least one sequence of audible tones may be a musical song which may be identifiable to the indicia, or may have some relationship or association with the indicia. The plurality of light sources may flash in a pattern in accordance with the at least one sequence of audible tones. The flag assembly may include a switch to control power to the plurality of light sources, and a switch to control power to the at least speaker.

Another embodiment of the invention features a flag assembly having a piece of material, a plurality of light sources, and at least one speaker adapted to play at least one sequence of audible tones. The at least one sequence of audible tones may be a musical song which is identifiable to the indicia. The plurality of light sources may flash in a pattern in accordance with the at least one sequence of audible tones. The flag assembly may include a switch to control power to the plurality of light sources, and a switch to control power to the at least speaker.

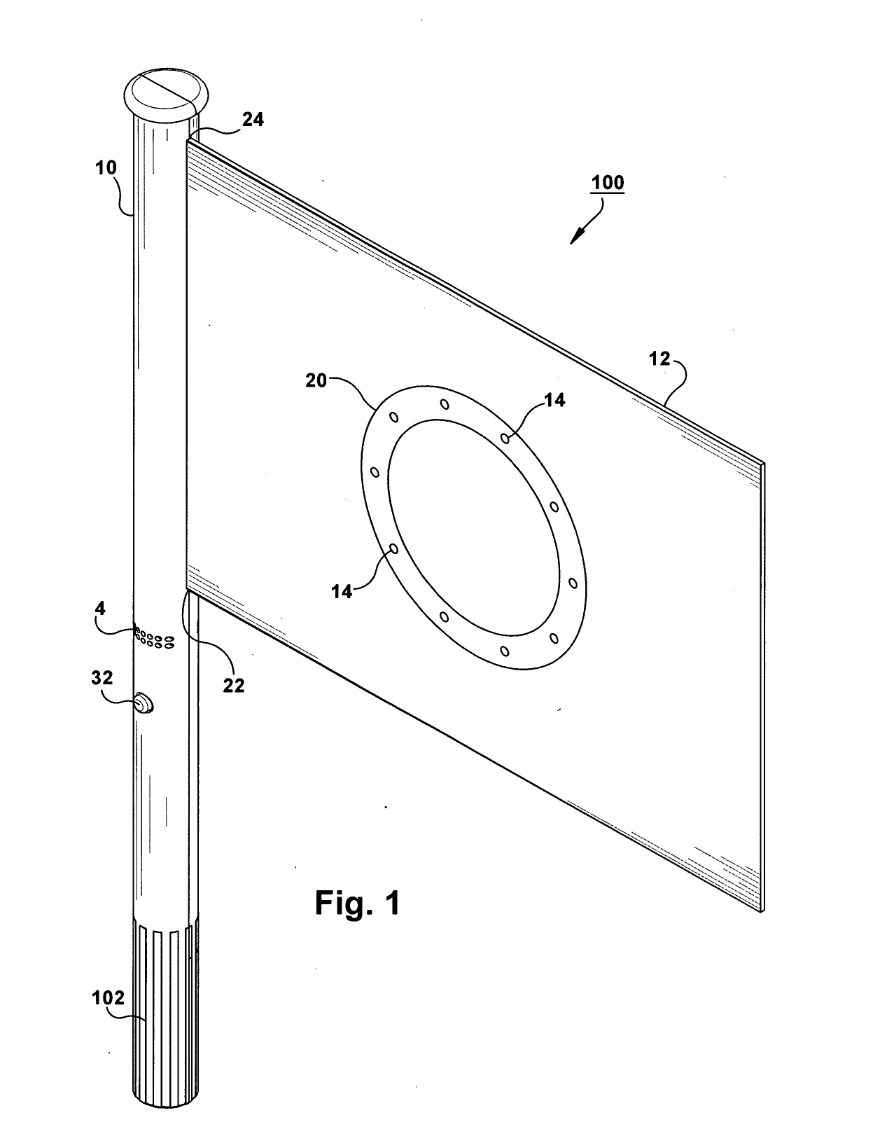

Referring now to the drawings, an exemplary flag assembly is shown in FIGS. 1-4. The flag assembly is suitable for display inside or outside. The flag assembly includes a plurality of lights to increase visibility to an observer when the flag is displayed outside at night, outside within a crowd, such as a sporting event, or inside when the conventional room lights are not powered.

Now referring to FIG. 1, a front view of a flag assembly 100 is shown. The flag assembly 100 includes a pole 10, a piece of material 12 attached to the pole 10, and a plurality of light sources 14 attached to the piece of material 12.

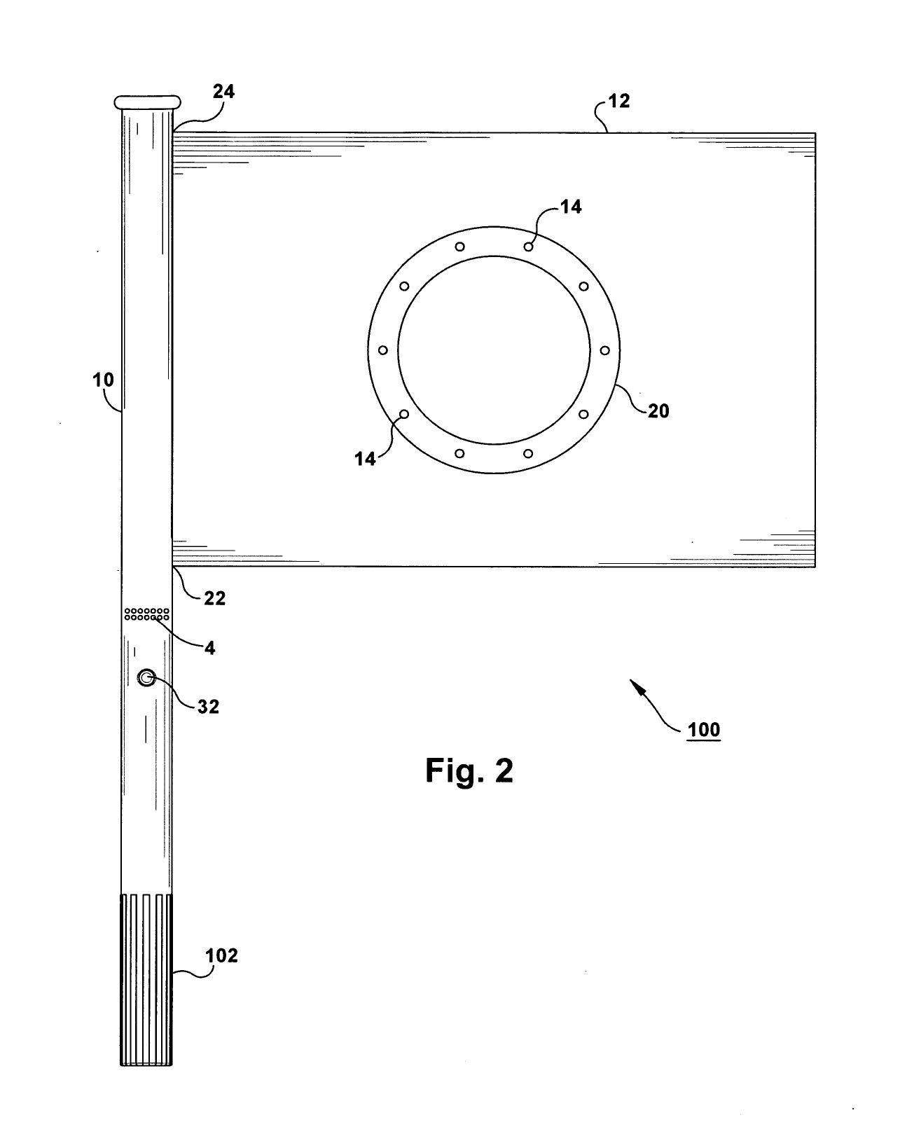

The pole 10 can be constructed of any material of suitable strength relative to the size and weight of the piece of material 12 and the proposed display application. In other words, the pole 10 may be a hand-held wooden stick only six inches in length, or may be a steel flag pole over 50 feet in length. The flag may be opaque or clear. As shown in FIG. 2, the pole 10 may include at least one light sources 16. In the practice of the invention, it is also possible to display the flag material 12 by hanging from the corners 22, 24. The piece of material 12 may be any size or shape, such as a pennant, display bunting, or a rectangle.

The piece of material defines a non-electrically powered indicia on at least one face. In the exemplary material shown, the non-electrically powered indicia 20 is the letter “O”. In the practice of the invention, the non-electrically powered indicia may be one or more letters, numbers, symbols, stripes, colors or other patterns, or any combination. Further, the invention may be practiced with a flag which is blank, or a flag which is a solid color o is white or black.

Still referring to FIG. 1, a plurality of light sources 14 are attached to the piece of material 12 in a pattern complementing the indicia. The lights may be of any suitable type, such as for example, a light emitting diode, in individual or strip form, or electroluminescent wire. The lights may be any color. The lights 14, 16 may be powered by a power source contained within the flag assembly, such as a battery within the pole, or may be powered by electricity from a near-by power source. For example, the flag assembly 10 includes a battery pack 30 for storing batteries.

The lights in the material may complement the indicia in one of several ways. As shown, the lights sources 14 are within the letter “O” in a mirror pattern relative to the indicia. In the practice of the invention, lights can be arranged in a complementing pattern which does not mirror the indicia.

The exemplary flag assembly 100 includes a speaker 4 attached encased within the flag pole 10. Similar to the plurality of lights, the speaker 4 may also be attached to an outside surface of the material 12, or may be embedded within the material 12. The speaker is adapted to play at least one sequence of audible tones, such as for example, a college fight song or a patriotic song. In one example, the sequence of audible tones is a musical song which is identifiable to the indicia 20 on the material 12. In another example, the plurality of light sources 14 flash in a pattern to compliment the at least one sequence of audible tones.

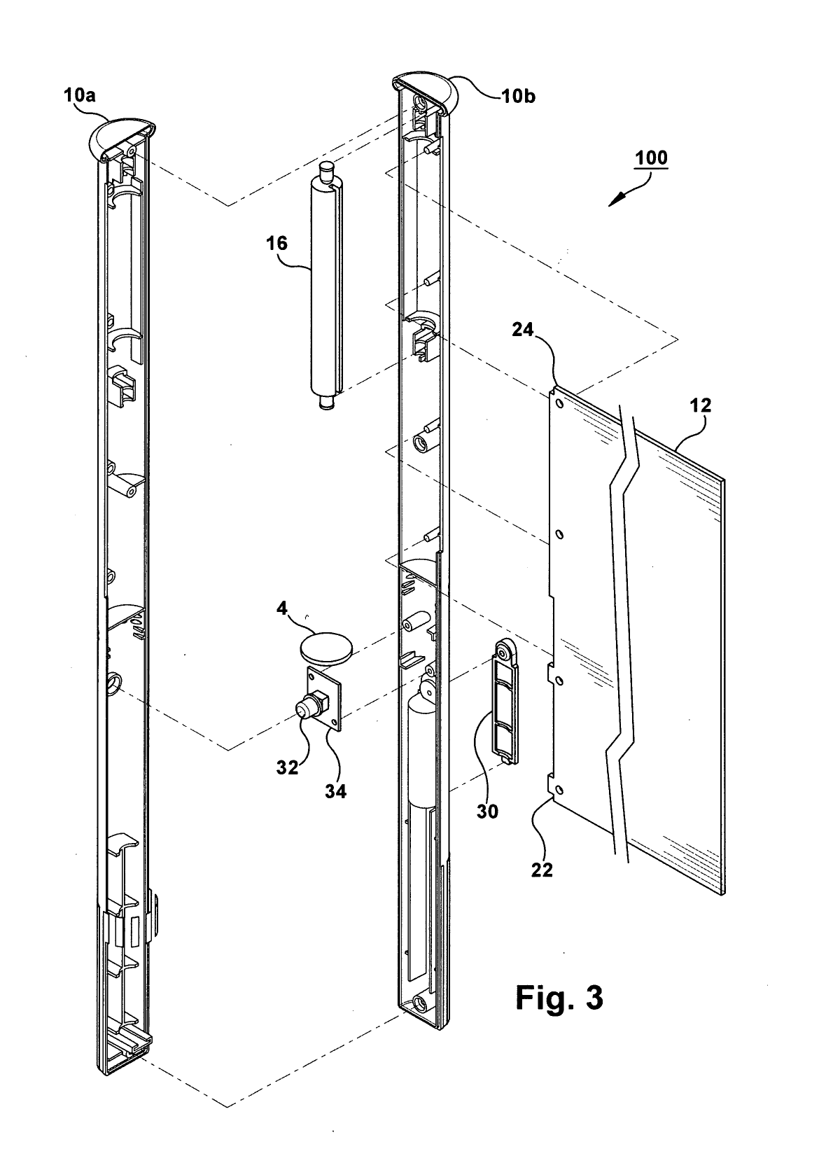

The flag assembly may include other features. The exemplary flag assembly 100 in FIG. 1 includes at least one switch 32. As shown in FIG. 3, the switch is a button switch attached to an IC circuit board 34. The switch may control power to the speaker and power to the lights. Alternatively, the flag assembly may have a separate switch for each of the speaker and the lights. The switch 32 is located on the outside surface of the pole 10, but can be located in other parts of the assembly during the practice of this invention. The switch 32 is operable by a user to control power to the plurality of light sources 14, 16. The switch may have multiple settings for the lights, such as for example, a high, low, and strobe setting. The switch may be operated remotely by a remote control or automatically by a photo sensor. The music switch may be operable by a user to control power to the speaker 4, and may include a volume setting. The switch may be hard wired to the lights and to the speaker, or may send wireless signals to the lights.

FIGS. 1-2 illustrate another feature of the flag pole 10. The bottom of the pole includes a gripping region 102. The gripping region adds friction to the pole. An exemplary gripping region may be a material coating or covering the pole, such as a grip made from silicone. Other suitable grip materials and structures may be used in the practice of this invention.

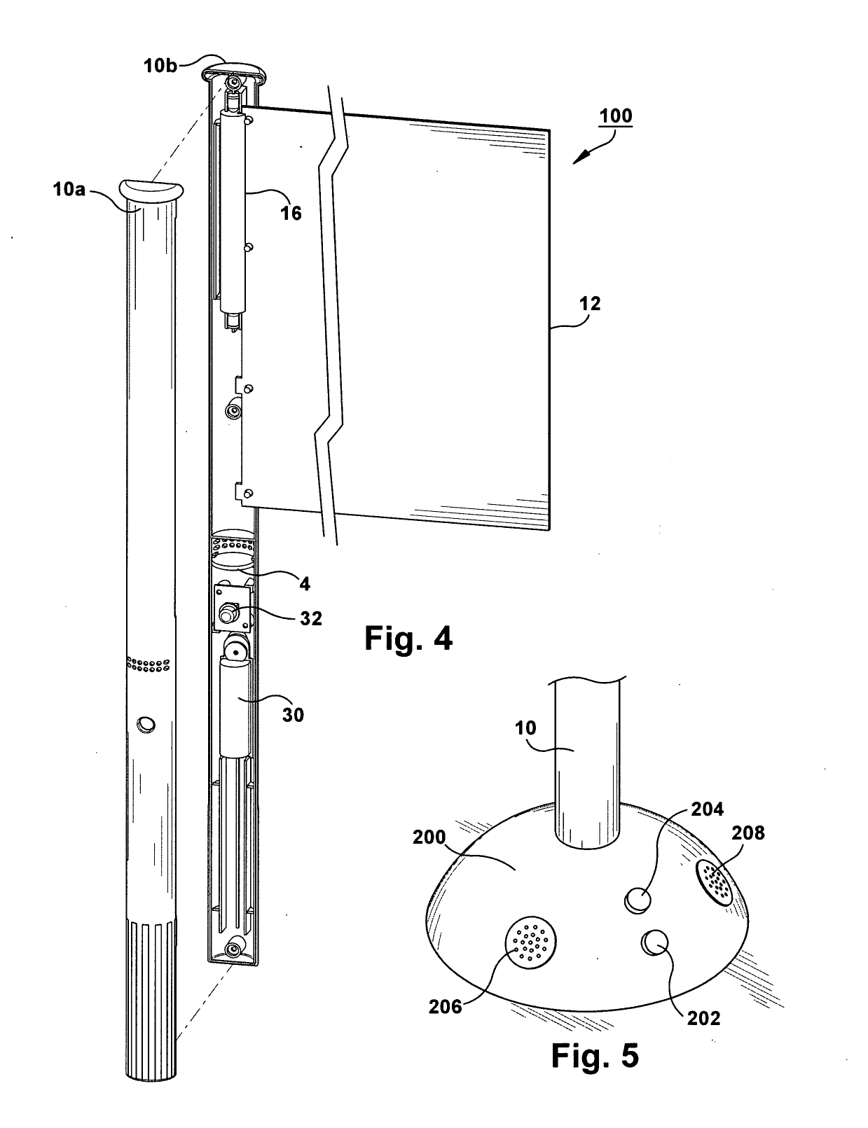

Referring now to FIGS. 3 and 4, other features of the exemplary flag assembly 100 are illustrated. FIG. 3 is an exploded assembly view of the flag assembly 100, and FIG. 4 is a sectional view of the flag assembly 100 shown along the longitudinal axis of the flag pole 10. Any indicia 20 on the flag 12 is not shown for clarity.

The flag pole 10 is constructed on two portions 10a, 10b which connect by standard hardware. This structure is exemplary and the invention may be practiced with other flag structure, such as a tube with an accessible opening at one or both ends, or a tube with a section removable which extends less than the longitudinal length of the tube.

As discussed herein, the flag assembly 10 includes a circuit board. The circuit board 34 may be an audio circuit board. In the practice of the invention, the circuit board may be adapted to be programmable, WiFi enabled, or Bluetooth enabled.

Features of the present invention apply to the gaining industry. For example, an individual player or a team may be identified in an electronic game by a virtual flag. The virtual flag may include indicia which is identifiable to the team identity. The virtual flag may also include a pattern of virtual lights which complement the indicia. A song may play at different points during the virtual game such that the song is detectable to the game player to further identify the virtual flag when it is visible to the player.

FIG. 5 shows a front view of a stand 200 and a portion of a flag pole 10. The exemplary stand 200 has an aperture (not shown) on a top surface into which a handle mount, or the bottom end, of the pole 10 may be inserted. Alternatively, the handle mount may be magnetic and attachable to a surface, such as for example, a car roof. In the illustrated example, the switches 202, 204 are located on the stand 200, to control power to the lights and speakers, respectively. Two stereo speakers 206, 206 are also located on the stand.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A flag assembly comprising:
a pole; and
a piece of material attached to the pole; and
at least one electrically-powered entity identifying indicia within the assembly.

2. The flag assembly of claim 1, wherein the at least one electrically-powered entity indicia is plurality of light sources attached to the piece of material in a pattern.

3. The flag assembly of claim 1, wherein the at least one electrically-powered entity indicia is plurality of light sources attached to the piece of material in a pattern complementing non-lighted indicia within the piece of material.

4. The flag assembly of claim 1, wherein the at least one electrically-powered entity indicia is a light source encased within the pole.

5. The flag assembly of claim 1, wherein the at least one electrically-powered entity indicia is at least one speaker adapted to play at least one sequence of audible tones.

6. The flag assembly of claim 5, wherein the at least one sequence of audible tones is a musical song which is identifiable to other indicia by at least one relatable feature.

7. The flag assembly of claim 6 wherein the other indicia is a plurality of light sources flashing in a pattern in accordance with the at least one sequence of audible tones.

8. The flag assembly of claim 1 further comprising a switch to control power to the at least one electrically-powered entity indicia.

9. The flag assembly of claim 1 further comprising a circuit board to control the at least one electrically-powered entity indicia.

10. A flag assembly comprising:
a pole;
a piece of material attached to the pole, wherein the material defines an indicia on at least one face; and
a plurality of light sources attached to the piece of material in a pattern complementing the indicia.

11. The flag assembly of claim 10 further comprising at least one speaker adapted to play at least one sequence of audible tones.

12. The flag assembly of claim 11 wherein the at least one sequence of audible tones is a musical song which is identifiable to the indicia by at least one relatable feature.

13. The flag assembly of claim 11 wherein the indicia is identifiable to the at least one sequence of audible tones.

14. The flag assembly of claim 11 wherein the plurality of light sources flash in a pattern in accordance with the at least one sequence of audible tones.

15. The flag assembly of claim 10 further comprising a switch to control power to the plurality of light sources.

16. The flag assembly of claim 11 further comprising a switch to control power to the at least speaker.

17. A flag assembly comprising:
a piece of material, wherein the material defines an indicia on at least one face;
a plurality of light sources attached to the piece of material in a pattern complementing the indicia; and
at least one speaker adapted to play at least one sequence of audible tones.

18. The flag assembly of claim 17 wherein the at least one sequence of audible tones is a musical song which is identifiable to the indicia.

19. The flag assembly of claim 17 wherein the indicia is identifiable to the at least one sequence of audible tones.

20. The flag assembly of claim 17 wherein the plurality of light sources flash in a pattern in accordance with the at least one sequence of audible tones.
